(19) United States
(12) Patent Application Publication
(10) Pub. No.: US 2011/0057978 A1
(43) Pub. Date: Mar. 10, 2011

(54) PRINTING APPARATUS

(75) Inventor: Hiromasa Harashina, Shizuoka (JP)

(73) Assignee: TOSHIBA TEC KABUSHIKI KAISHA, Tokyo (JP)

(21) Appl. No.: 12/860,486

(22) Filed: Aug. 20, 2010

(30) Foreign Application Priority Data
Sep. 10, 2009 (JP) 2009-208795

(51) Int. Cl. B41J 29/38

(52) U.S. Cl. 347/16

(57) ABSTRACT

According to one embodiment, a printing apparatus includes a transverse adjusting mechanism and an abutting frame. The transverse adjusting mechanism moves a passbook in a direction perpendicular to the conveying direction to make a first side of the passbook abut on the abutting frame while the passbook set to be inserted to a medium inlet is being received and conveyed. Accordingly, the transverse adjusting mechanism positions the passbook with respect to a printing region of a dot head, and retracts the abutting frame from a conveying path while a statement paper is being conveyed. The printing apparatus includes a controller to determine whether the first side of the passbook is placed inward from the abutting frame. The controller controls receiving and conveying the inserted passbook based on the determination result.

### CROSS-REFERENCE TO RELATED APPLICATIONS

This application is based upon and claims the benefit of priority from Japanese Patent Application No. 2009-208795, filed on Sep. 10, 2009, the entire contents of which is incorporated herein by reference.

### FIELD

Embodiments described herein relate generally to a printing apparatus to be used for example in an automated teller machine (“ATM”) which is used for a bank.

### BACKGROUND

A conventional printing apparatus includes two different types of printing devices. One of the printing devices includes a dot printing unit for performing a printing operation on a passbook (a first print medium) while the other one includes a thermal printing unit for performing a printing operation on a statement paper (a second print medium).

Such a printing apparatus includes separate conveying paths and medium inlets for the two different printing devices, respectively.

However, such a printing apparatus with two different conveying paths and medium inlets has a complicated configuration, which increases the manufacturing cost.

In this respect, a printing apparatus is contemplated to use a common conveying path and medium inlet for the two different printing devices, while maintaining the same printing performance.

In such a printing apparatus, a passbook is inserted to the medium inlet and is conveyed along the conveying path in a first direction to be printed by the dot printing unit. Then, the passbook is conveyed in a reverse direction to be discharged from the medium inlet. On the other hand, a statement paper is conveyed along the conveying path in a second direction opposite to the first direction in the printing apparatus, so as to be printed by the thermal printing unit. Then, the statement paper is discharged from the medium inlet.

On the conveying path of the printing apparatus is also arranged an abutting frame, which is movable frontward and backward to determine a position of a passbook. When a passbook is conveyed to a dot printing unit, the abutting frame operates to abut on the passbook to position the passbook with respect to a printing region of the dot printing unit by moving the passbook in a direction perpendicular to the conveying direction. Further, when a statement paper is conveyed, the abutting frame operates to retract from the conveying path to avoid colliding with a statement paper.

Since the width of the medium inlet corresponds to that of a statement paper, which is generally larger than that of a passbook, the medium inlet is provided with a guide member for restricting the insertion position of a passbook so that the passbook is set to be inserted at a correct position, i.e. where the passbook would not collide with the abutting frame while the passbook is being conveyed.

### BRIEF DESCRIPTION OF THE DRAWINGS

FIG. 1 is a side view illustrating a printing apparatus according to one embodiment.

FIG. 2 is a top view illustrating a printing apparatus according to one embodiment.

FIG. 3 is a front view illustrating a printing apparatus according to one embodiment.

FIG. 4 is a perspective view illustrating a medium inlet according to one embodiment.

FIG. 5 is a view illustrating the state in which an abutting frame in the printing apparatus positions a passbook at a printing region of a dot printing unit.

FIG. 6 is a view illustrating the state in which an abutting frame in the printing apparatus positions a print region of a passbook at a printing region of a dot printing unit.

FIG. 7 is a block diagram illustrating a drive control system of a printing apparatus according to one embodiment.

### DETAILED DESCRIPTION

According to one embodiment, a printing apparatus includes a medium inlet, a conveying unit, a serial head, a line head, a positioning unit, and a control unit. The conveying unit has a conveying path communicating with the medium inlet to receive and convey a first print medium in a first direction along the conveying path, the first print medium set to be inserted to the medium inlet. The conveying unit then conveys and discharges the first print medium through the medium inlet in a second direction reverse to the first direction. The conveying unit also conveys and discharges a second print medium through the medium inlet in the second direction along the conveying path, the width of the second print medium larger than that of the first print medium. The serial head is employed to print information on the first print medium, while the line head is employed to print information on the second print medium. The serial head and the line head are arranged along the conveying path in the direction of conveying the print medium. The positioning unit moves the first print medium in a direction intersecting the conveying direction to make a first side of the first print medium abut on an abutting frame while the first print medium is being received and conveyed, thereby positioning the first print medium with respect to a printing region of the serial head. The positioning unit retracts the abutting frame from the conveying path while the second print medium is being conveyed. The control unit determines whether or not the first side of the first print medium is placed inward from the abutting frame, and controls receiving and conveying of the first print medium based on the determination result.

Embodiments will now be described in detail with reference to the accompanying drawings.

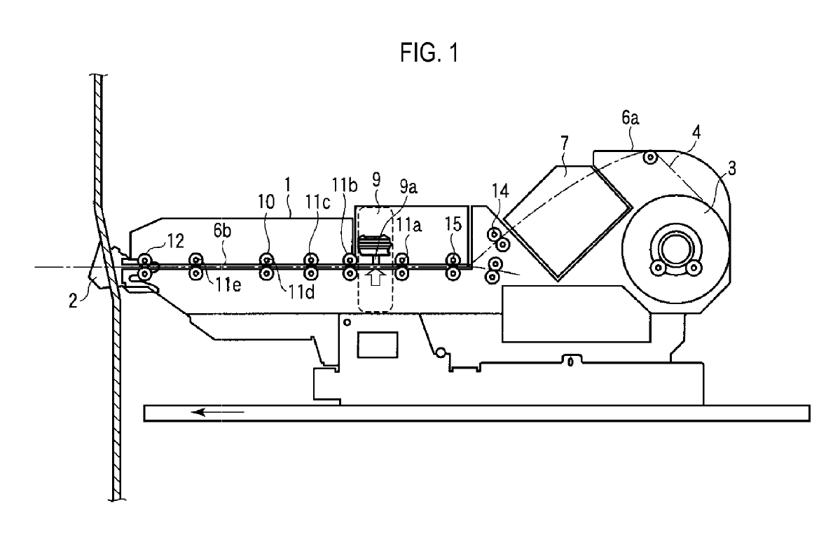

FIG. 1 is a side view illustrating a printing apparatus according to one embodiment.

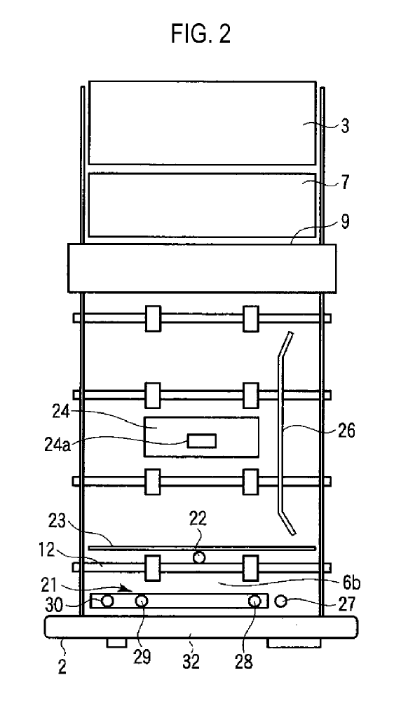

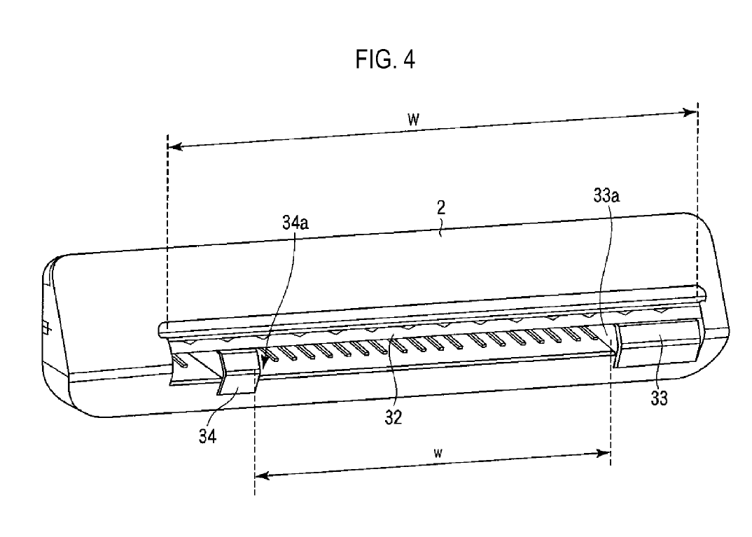

The printing apparatus includes a main body 1 having an opening portion 2 at the front end of the main body 1. The opening portion 2 includes a medium inlet 32 (see FIGS. 2 and 4), which is used as an inlet for a passbook (a first print medium) as well as an outlet for a statement paper (a second print medium).

In the rear side of main body 1, a paper loader 3 is installed for loading a rolled thermal paper 4. A tip portion of the thermal paper 4 is dispensed from the paper loader 3 and is conveyed along a conveying path 6a. Along the conveying path 6a, a thermal printing unit 7 including a line head and a cutter (not shown) are sequentially arranged in the direction of conveying the thermal paper 4.

The main body 1 also includes a passbook conveying mechanism 10 for conveying a passbook along a conveying path 6b. The conveying path 6b is connected with the conveying path 6a for conveying the thermal paper 4, so that the passbook conveying mechanism 10 also serves as a conveying means for conveying along the conveying path 6b the thermal paper 4 that is discharged from the conveying path 6a.

The passbook conveying mechanism 10 includes a plurality of pairs of conveying rollers 11a to 11e, entering rollers 12, and feeding rollers 15, which are spaced by predetermined intervals along the conveying path 6b. A dot printing unit 9 having a dot head 9a as a serial head is arranged in the conveying path 6b for conveying a passbook, the conveying path 6b communicating with the opening portion 2.

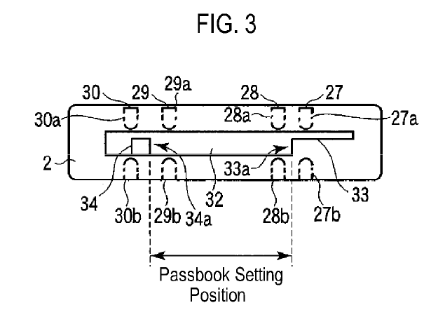

FIG. 2 is a top view illustrating the internal configuration of the printing apparatus according to one embodiment. FIG. 3 is a front view illustrating opening portion 2 at the front end of the printing apparatus.

Along the conveying path 6b of the main body 1, a detecting unit 21, a passbook tip detecting sensor 22, a shutter 23 and a transverse adjusting mechanism 24 as a positioning means are sequentially arranged in the direction of receiving and conveying a passbook. An abutting frame 26 is mounted in the vicinity of one side of the transverse adjusting mechanism 24.

The detecting unit 21 includes first to fourth detecting sensors 27 to 30, which are arranged in the vicinity of the opening portion 2 along a longitudinal direction of medium inlet 32 of the opening portion 2. The first to fourth detecting sensors 27 to 30 may include light-emitting elements 27a to 30a and light-receiving elements 27b to 30b which are respectively arranged opposite to the light-emitting elements 27a to 30a with the conveying path 6b interposed therebetween.

The passbook tip detecting sensor 22 may include a light-emitting element and a light-receiving element which are arranged opposite to each other with the conveying path 6b interposed therebetween.

The shutter 23 is configured to be switchable, which is opened when it is determined that the passbook is set to be correctly inserted at a predetermined position of the medium inlet 32, as will be described later.

The transverse adjusting mechanism 24 includes an adjusting roller 24a which rotates to move a passbook in a direction perpendicular to the direction of conveying the passbook.

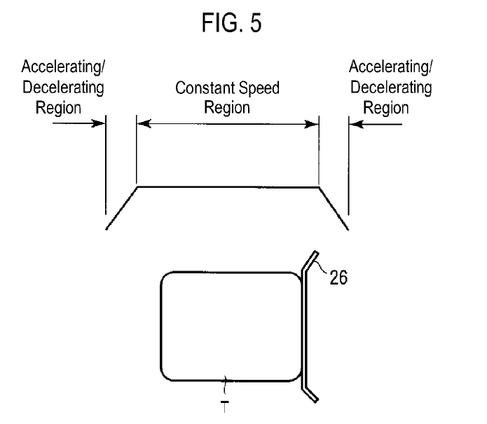

As shown in FIG. 5, a passbook is conveyed by the rotation of the adjusting roller 24a so that a first side of the passbook abuts on the abutting frame 26, which positions the passbook with respect to a printing region (a constant speed region) of the dot printing unit 9.

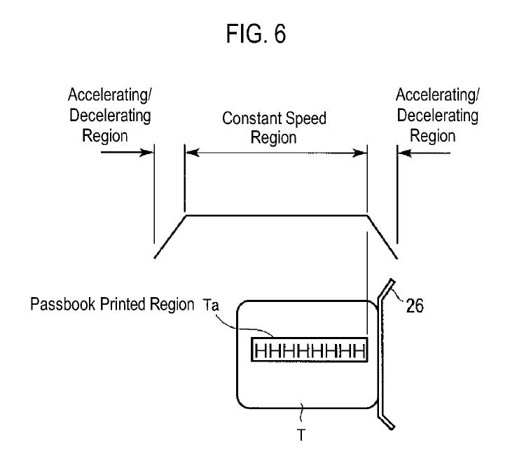

In addition, the abutting frame 26 is configured to be movable in a direction perpendicular to the direction of conveying the passbook. To change the state as shown in FIG. 5 to the state as shown in FIG. 6, the abutting frame 26 may be moved outward by a predetermined distance to position a print region Ta of a passbook T with respect to the printing region (the constant speed region) of the dot printing unit 9.

Further, when a statement paper, whose width is larger than that of the passbook, is conveyed to approach the abutting frame 26, the abutting frame 26 is configured to retract from the conveying path 6b to avoid colliding with the statement paper.

As shown in FIGS. 3 and 4, the opening portion 2 includes the medium inlet 32 having width W. Along a longitudinal direction of the medium inlet 32, a first guide 33 is fixedly installed on one end of the medium inlet 32 while a second guide 34 is movably installed on the other end thereof to be movable in the longitudinal direction.

The width W of the medium inlet 32 corresponds to the maximum allowable size of a statement paper while width w between the first guide 33 and the second guide 34 corresponds to the maximum allowable size of a passbook.

Respective sides of the first and second guides 33 and 34 opposite each other become guide faces 33a and 34a. A passbook is guided by the guide faces 33a and 34a of the first and second guides 33 and 34 and is set to be inserted into the medium inlet 32. The guide face 33a of the first guide 33 is positioned inward relative to the abutting frame 26.

In the meantime, among the first to fourth detecting sensors 27 to 30 of the detecting unit 21, the first detecting sensor 27 is fixedly installed outward from the guide face 33a of the first guide 33, while the second detecting sensor 28 is fixedly installed inward from the guide face 33a of first guide 33, as shown in FIGS. 2 and 3. The first detecting sensor 27 is installed to be aligned with a tip portion of the abutting frame 26.

The third detecting sensor 29 is placed inward from the guide face 34a of the second guide 34, while the fourth detecting sensor 30 is placed outward from the guide face 34a of the second guide 34. The third and fourth detecting sensors 29 and 30 are movably installed in the longitudinal direction of the medium inlet 32.

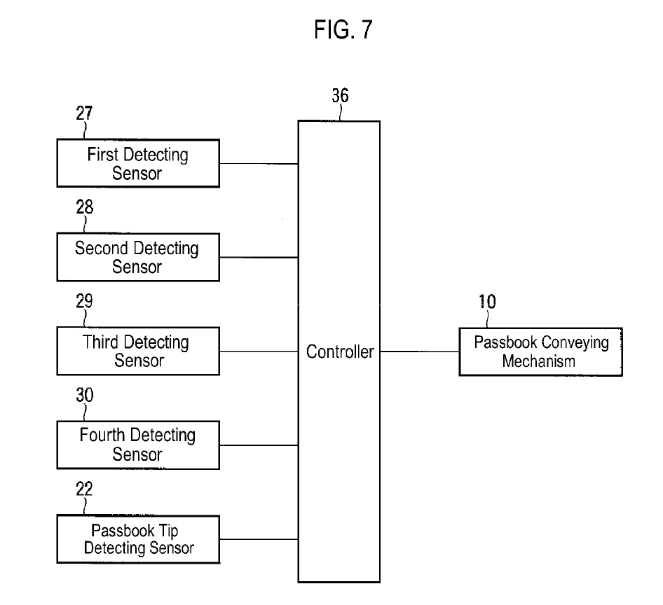

FIG. 7 shows an exemplary embodiment of a drive control system of the passbook conveying mechanism 10.

The first to fourth detecting sensors 27 to 30 and the passbook tip detecting sensor 22 are connected to a controller 36 via a signaling circuit. Further, the controller 36 is connected to the passbook conveying mechanism 10 via a control circuit.

Upon inserting a passbook, the controller 36 is configured to drive the passbook conveying mechanism 10 if it is determined that the passbook is set to be correctly inserted at a predetermined position. Such determination is made based on whether the tip portion of the passbook is detected by the second and third detecting sensors 28 and 29, which are arranged inward from the first and second guides 33 and 34, among the first to fourth detecting sensors 27 to 30.

Further, upon inserting a passbook, the controller 36 is also configured to stop driving the passbook conveying mechanism 10 if it is determined that the passbook is set to be inserted departing from a predetermined position. Such determination is made based on whether the tip portion of the passbook is detected by the first and fourth detecting sensors 27 and 30, which are arranged outward from the first and second guides 33 and 34, among the first to fourth detecting sensors 27 to 30.

In the following, the operation of receiving and conveying a passbook will be described.

When a passbook is inserted through the medium inlet 32 and the tip portion of the passbook abut on the shutter 23, the passbook is detected by the detecting unit 21 and the passbook tip detecting sensor 22. At this point, if the passbook is not detected by the first and fourth detecting sensors 27 and 30, while it is detected by the second and third detecting sensors 28 and 29, the controller 36 determines that the passbook is set to be correctly inserted at a predetermined position.

Upon the above determination by the controller 36, the shutter 23 operates to open and the passbook conveying mechanism 10 is driven to convey the passbook along the conveying path 6b. Then, when the passbook reaches the transverse adjusting mechanism 24, the passbook is conveyed in a transverse direction by the rotation of the adjusting roller 24a to abut on the abutting frame 26. The abutting frame 26 then positions the passbook with respect to the printing region of the dot printing unit 9, as shown in FIGS. 5 and 6. The positioned passbook is conveyed to a dot printing position to be printed by the dot head 9a. When the printing is completed, the passbook conveying mechanism 10 is driven in a reverse direction, so that the passbook is reversely conveyed to be discharged through the medium inlet 32.

In the meantime, when a passbook is set to be inserted, if the passbook is not detected by the second and third detecting sensors 28 and 29, while it is detected by the first detecting sensor 27, the controller 36 determines that a passbook having a different width is disposed over the first guide 33. In this case, the controller 36 stops receiving the passbook without opening the shutter 23.

Further, even if a passbook is received upon determining that the passbook be set to be correctly inserted at a predetermined position of the medium inlet 32, as described above, the passbook may be detected by the first detecting sensor 27 on the way of being received. In this case, the passbook is determined to be received in an inclined state, and the receiving operation stops.

Moreover, in case a statement paper is to be printed, the thermal paper 4 is conveyed by the rotation of a platen roller so that it can be printed with information by heat of a thermal head. After printing, the thermal paper 4 passes through a cutter to be delivered by a pair of thermal-side feeding rollers 14. When the thermal paper 4 is conveyed a certain distance, the thermal paper 4 is cut to have a certain size to form a statement paper. The statement paper is reversely conveyed along the conveying path 6b by the reverse rotation of the pair of feeding rollers 15, the pairs of conveying rollers 11a to 11e, and the pair of entering rollers 12, and then is discharged from the medium inlet 32.

As set forth above, according to the exemplary embodiment, when a passbook is not set to a correct position or when a passbook is correctly set but to become inclined on the way of being receiving, the operation of receiving the passbook stops, thereby preventing occurrence of jamming and damage of the passbook.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing apparatus comprising:
a medium inlet;
a conveying unit having a conveying path communicating with the medium inlet, the conveying unit being configured to receive a first print medium through the medium inlet and further being configured to convey the first medium in a first direction along the conveying path and then convey and discharge the first print medium through the medium inlet in a second direction reverse to the first direction, and the conveying unit further being configured to convey and discharge a second print medium through the medium inlet in the second direction along the conveying path, the width of the second print medium larger than that of the first print medium;
a serial head configured to print information on the first print medium and a line head configured to print information on the second print medium, the serial head and line head being arranged along the conveying path in the direction of conveying the print media;
a positioning unit configured to move the first print medium in a direction intersecting the conveying direction to make a first side of the first print medium abut on an abutting frame while the first print medium is being received and conveyed, thereby positioning the first print medium with respect to a printing region of the serial head, and configured to retract the abutting frame from the conveying path while the second print medium is being conveyed; and
a control unit configured to determine whether the first side of the first print medium is placed inward from the abutting frame, and configured to control receiving and conveying the first print medium based on the determination result.

2. The apparatus of claim 1, further comprising a plurality of detecting sensors which are arranged in the vicinity of the medium inlet to be spaced apart by a predetermined interval in a longitudinal direction of the medium inlet, wherein the control unit controls receiving and conveying the first print medium based on the detection results of the plurality of detecting sensors.

3. The apparatus of claim 1, further comprising first and second guides which are arranged in the medium inlet to be spaced apart by a predetermined interval in a longitudinal direction of the medium inlet, the first print medium set to be inserted between the first guide and the second guide.

4. The apparatus of claim 3, further comprising:
first to fourth detecting sensors which are arranged in the vicinity of the medium inlet in a longitudinal direction of the medium inlet, wherein the first and second sensors are arranged with the first guide interposed therebetween, and the third and fourth sensors are arranged with the second guide interposed therebetween; and
a shutter sequentially arranged with respect to the first to fourth detecting sensors in the direction of receiving and conveying the first print medium,
wherein when the first print medium is inserted through the medium inlet and a tip portion of the first print medium abut on the shutter, if the first print medium is not detected by the first and fourth detecting sensors, while it is detected by the second and third detecting sensors, the control unit determines that the first print medium is set to be correctly inserted at a predetermined position of the medium inlet.

5. The apparatus of claim 4, wherein when the first print medium is set to be inserted into the medium inlet, if the first print medium is not detected by the second and third detecting sensors, while it is detected by the first detecting sensor, the control unit determines that the first print medium is disposed over the first guide, and stops receiving the first print medium.

6. The apparatus of claim 4, wherein upon determining that the first print medium be set to be correctly inserted at a predetermined position of the medium inlet, if the first print medium is detected by the first detecting sensor while the first print medium being received, the control unit determines the first print medium to be received in an inclined state, and stops receiving the first print medium.

7. The apparatus of claim 1, wherein the serial head is a dot head, and the line head is a thermal head.

8. The apparatus of claim 1, wherein the positioning unit is further configured to move the abutting frame outward from the first print medium by a predetermined distance to position a print region of the first print medium with respect to the printing region of the serial head.

9. The apparatus of claim 1, wherein after the second print medium is printed by the line head, the conveying unit conveys the second print medium through a cutter, which cuts the second print medium to have a certain size, and then conveys the second print medium in a reverse direction along the conveying path to be discharged from the medium inlet.

10. A printing apparatus comprising:
a medium inlet;
a conveying unit having a conveying path communicating with the medium inlet, configured to receive a first print medium through the medium inlet and convey the first medium in a first direction along the conveying path and then convey and discharge the first print medium through the medium inlet in a second direction reverse to the first direction, and configured to convey and discharge a second print medium through the medium inlet in the second direction along the conveying path, the width of the second print medium larger than that of the first print medium;
a positioning unit configured to move the first print medium in a direction intersecting the conveying direction to position the first print medium with respect to an abutting frame; and
a control unit configured to determine whether or not the first side of the first print medium is placed apart from the abutting frame, and configured to control receiving and conveying the first print medium based on the determination result.

11. The apparatus of claim 10, wherein the positioning unit is further configured to make a first side of the first print medium abut on the abutting frame while the first print medium is being received and conveyed, and configured to retract the abutting frame from the conveying path while the second print medium is being conveyed.

12. The apparatus of claim 11, wherein the positioning unit is further configured to move the abutting frame outward from the first print medium by a predetermined distance to position a print region of the first print medium with respect to a predetermined printing region on the conveying path.

13. The apparatus of claim 11, further comprising:
first and second guides which are arranged in the medium inlet to be spaced apart by a predetermined interval in a longitudinal direction of the medium inlet, the first print medium set to be inserted between the first guide and the second guide;
first to fourth detecting sensors which are arranged in the vicinity of the medium inlet in a longitudinal direction of the medium inlet, wherein the first and second sensors are arranged with the first guide interposed therebetween, and the third and fourth sensors are arranged with the second guide interposed therebetween; and
a shutter sequentially arranged with respect to the first to fourth detecting sensors in the direction of receiving and conveying the first print medium,
wherein when the first print medium is inserted through the medium inlet and a tip portion of the first print medium abut on the shutter, if the first print medium is not detected by the first and fourth detecting sensors, while it is detected by the second and third detecting sensors, the control unit determines that the first print medium is set to be correctly inserted at a predetermined position of the medium inlet.

14. The apparatus of claim 13, wherein when the first print medium is set to be inserted into the medium inlet, if the first print medium is not detected by the second and third detecting sensors, while it is detected by the first detecting sensor, the control unit determines that the first print medium is disposed over the first guide, and stops receiving the first print medium.

15. The apparatus of claim 14, wherein upon determining that the first print medium be set to be correctly inserted at a predetermined position of the medium inlet, if the first print medium is detected by the first detecting sensor while the first print medium being received, the control unit determines the first print medium to be received in an inclined state, and stops receiving the first print medium.

16. A method for positioning print medium in a printer, the method comprising:
receiving a first print medium through a medium inlet and conveying the first medium in a first direction along a conveying path communicating with the medium inlet;
conveying and discharging the first print medium through the medium inlet in a second direction reverse to the first direction;
conveying and discharging a second print medium through the medium inlet in the second direction along the conveying path, the width of the second print medium being larger than that of the first print medium;
moving the first print medium in a direction intersecting the conveying direction to position the first print medium with respect to an abutting frame in the printer; and
determining whether or not the first side of the first print medium is placed apart from an abutting frame, and controlling receiving and conveying the first print medium based on the determination result.

17. The method of claim 16, wherein the positioning comprises:
making a first side of the first print medium abut on the abutting frame while the first print medium is being received and conveyed; and
retracting the abutting frame from the conveying path while the second print medium is being conveyed.

18. The method of claim 16, wherein the positioning includes moving the abutting frame outward from the first print medium by a predetermined distance to position a print region of the first print medium with respect to the predetermined printing region.

19. The method of claim 16, wherein the printer comprises:
first and second guides which are arranged in the medium inlet to be spaced apart by a predetermined interval in a longitudinal direction of the medium inlet, the first print medium set to be inserted between the first guide and the second guide;
first to fourth detecting sensors which are arranged in the vicinity of the medium inlet in a longitudinal direction of the medium inlet, wherein the first and second sensors are arranged with the first guide interposed therebetween, and the third and fourth sensors are arranged with the second guide interposed therebetween; and
a shutter sequentially arranged with respect to the first to fourth detecting sensors in the direction of receiving and conveying the first print medium,
wherein the method further comprises:
when first print medium is inserted through the medium inlet and a tip portion of the first print medium abut on the shutter, if the first print medium is not detected by the first and fourth detecting sensors, while it is detected by the second and third detecting sensors, determining that the first print medium is set to be correctly inserted at a predetermined position of the medium inlet.

20. The method of claim 19, further comprising, when the first print medium is set to be inserted into the medium inlet, if the first print medium is not detected by the second and third detecting sensors, while it is detected by the first detecting sensor, determining that the first print medium is disposed over the first guide, and stopping the receiving of the first print medium.
